(19) United States
(12) Patent Application Publication
(10) Pub. No.: US 2013/0268801 A1
(43) Pub. Date: Oct. 10, 2013

(54) SERVER MANAGEMENT APPARATUS, SERVER MANAGEMENT METHOD, AND PROGRAM

(71) Applicant: Junichi Yamato, Tokyo (JP)

(72) Inventor: Junichi Yamato, Tokyo (JP)

(73) Assignee: NEC CORPORATION, Minato-ku, Tokyo (JP)

(21) Appl. No.: 13/992,982

(22) PCT Filed: Sep. 9, 2011
(86) PCT No.: PCT/JP2011/005085

§ 371 Date: Jun. 10, 2013

(30) Foreign Application Priority Data
Dec. 10, 2010 (JP) 2010-275667

(51) Int. Cl. G06F 11/20

(52) U.S. Cl. CPC G06F 11/2028
USPC 714/4.11

(57) ABSTRACT

A server management apparatus monitors activity state of an active server that provides a service to a client(s) via a plurality of switches, instructs a route control apparatus, managing routing for the plurality of switches, to change a packet forwarding route if there is no reply from the active server; and recognizes that the active server is stopped if there is no reply from the active server after a forwarding route is changed and instructs a standby server to provide the service instead of the active server.

### TECHNICAL FIELD

### REFERENCES TO RELATED APPLICATION

The present invention is based upon and claims the benefit of the priority of Japanese patent application No. 2010-275667, filed on Dec. 10, 2010, the disclosure of which is incorporated herein in its entirety by reference thereto.

The present invention relates to a server management apparatus, a server management method, and a program. In particular, it relates to a server management apparatus, a server management method, and a program for managing a failure caused in a service provision system having an active server and a standby server.

### BACKGROUND ART

A configuration made to increase server availability and referred to as an HA (High Availability) cluster is known. In such HA cluster, two servers are used, one used as an active server and the other as a standby server. When the active server is in a normal state, the active server provides a service, and the standby server monitors the active server. If an abnormal operation of the active server is detected, the standby server takes over the process of the active server. In this way, countermeasure against the server failure is realized.

In addition, Patent Literature 1 describes a system for managing a server failure. In this system, by monitoring a session, a server failure is detected.

### CITATION LIST

### Patent Literature

[PTL 1]
Japanese Patent Kokai Publication No. 2007-156569A

### Non-Patent Literature

[NPL 1]
Nick McKeown and seven others, “OpenFlow: Enabling Innovation in Campus Networks,” online, searched on Sep. 29, 2010, Internet <URL:http://www.openflowswitch.org//documents/openflow-wp-latest.pdf>.
[NPL 2]
“OpenFlow Switch Specification Version 1.0.0. (Wire Protocol 0x01),” searched on Sep. 29, 2010, Internet <URL:http://www.openflowswitch.org/documents/openflow-spec-v1.0.0.pdf>.

### SUMMARY OF INVENTION

### Technical Problem

The entire disclosures of the above Patent Literature and Non-Patent Literature are incorporated herein by reference thereto. The following analyses are made by the present inventor.

There is a problem that a state of the network between both the servers and the client(s) cannot be taken into account in a case where a state of the active server is monitored by the standby server. This is because the standby server only monitors a state of the active server.

In addition, there is a problem that details of the network cannot be taken into account in a case where a failure is detected between a server and the client. This is because presence or absence of a failure is determined based on a state of the session between the client and the server.

Thus, even if service provision by a service provision system including an active server and a standby server is stopped by a failure in a server or by a failure in a network connecting the client and both the servers, the service needs to be recovered. It is an object of the present invention to provide a server management apparatus, a server management method, and a program that solve the above problems.

### Solution to Problem

According to a first aspect of the present invention, there is provided a server management apparatus, comprising: a server monitoring unit that monitors activity state of an active server that provides a service to a client(s) via a plurality of switches; a route change instruction unit that instructs a route control apparatus, managing routing for the plurality of switches, to change a packet forwarding route (path) if there is no reply from the active server; and a service provision instruction unit that recognizes that the active server is stopped if there is no reply from the active server after a forwarding route (path) is changed and instructs a standby server to provide the service instead of the active server.

According to a second aspect of the present invention, there is provided a server management method, comprising: by a server management apparatus, monitoring an activity state of an active server that provides a service to a client(s) via a plurality of switches; instructing a route control apparatus, managing routing for the plurality of switches, to change a packet forwarding route (path) if there is no reply from the active server; and recognizing that the active server is stopped if there is no reply from the active server after a forwarding route (path) is changed and instructing a standby server to provide the service instead of the active server.

According to a third aspect of the present invention, there is provided a program, causing a computer to execute: monitoring an activity state of an active server that provides a service to a client(s) via a plurality of switches; instructing a route control apparatus, managing routing for the plurality of switches, to change a packet forwarding route (path) if there is no reply from the active server; and recognizing that the active server is stopped if there is no reply from the active server after a forwarding route (path) is changed and instructing a standby server to provide the service instead of the active server.

The program may be recorded in a non-transient computer-readable storage medium.

### Advantageous Effects of Invention

Based on the server management apparatus, the server management method, and the program, even if service provision by a service provision system including an active server and a standby server is stopped by a failure in a server or by a failure in a network connecting the client(s) and both the servers, the service can be recovered.

### BRIEF DESCRIPTION OF DRAWINGS

FIG. 1 is a block diagram illustrating a configuration of a service provision system according to a first exemplary embodiment.

FIG. 2 is a block diagram illustrating another configuration of a service provision system according to the first exemplary embodiment.

FIG. 3 illustrates an entry in a flow table in OpenFlow.

FIG. 4 illustrates actions in OpenFlow.

FIG. 5 is a block diagram illustrating a configuration of a switch in the service provision system according to the first exemplary embodiment.

FIG. 6 is a flow chart illustrating an operation of a server management apparatus in the service provision system according to the first exemplary embodiment.

FIG. 7 is a block diagram illustrating a configuration of a server in a service provision system according to a second exemplary embodiment.

FIG. 8 is a flow chart illustrating an operation of a server management apparatus in the service provision system according to the second exemplary embodiment.

FIG. 9 is a flow chart illustrating an operation of a server management apparatus according to a third exemplary embodiment.

FIG. 10 is a flow chart illustrating an operation of the server management apparatus according to the third exemplary embodiment.

FIG. 11 is a flow chart illustrating an operation of a server management apparatus according to a fourth exemplary embodiment.

FIG. 12 is a flow chart illustrating another operation of the server management apparatus according to the fourth exemplary embodiment.

FIG. 13 is a flow chart illustrating an operation of a server management apparatus according to a fifth exemplary embodiment.

FIG. 14 is a flow chart illustrating an operation of the server management apparatus according to the fifth exemplary embodiment.

FIG. 15 is a flow chart illustrating an operation of the server management apparatus according to the fifth exemplary embodiment.

FIG. 16 is a block diagram illustrating a configuration of a server management apparatus according to the present invention.

### DESCRIPTION OF EMBODIMENTS

First, an outline of the present invention will be described. The reference signs in this outline are used only as examples to facilitate comprehension and are not intended to limit the present invention to the illustrated modes.

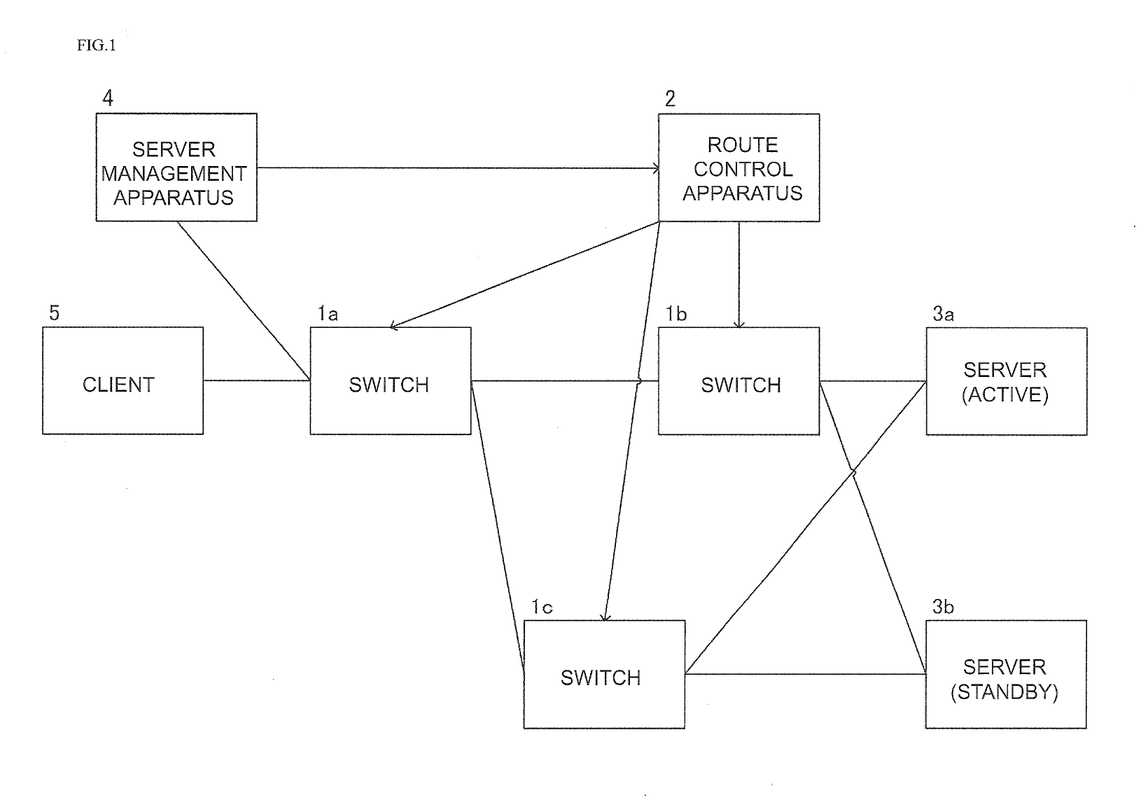

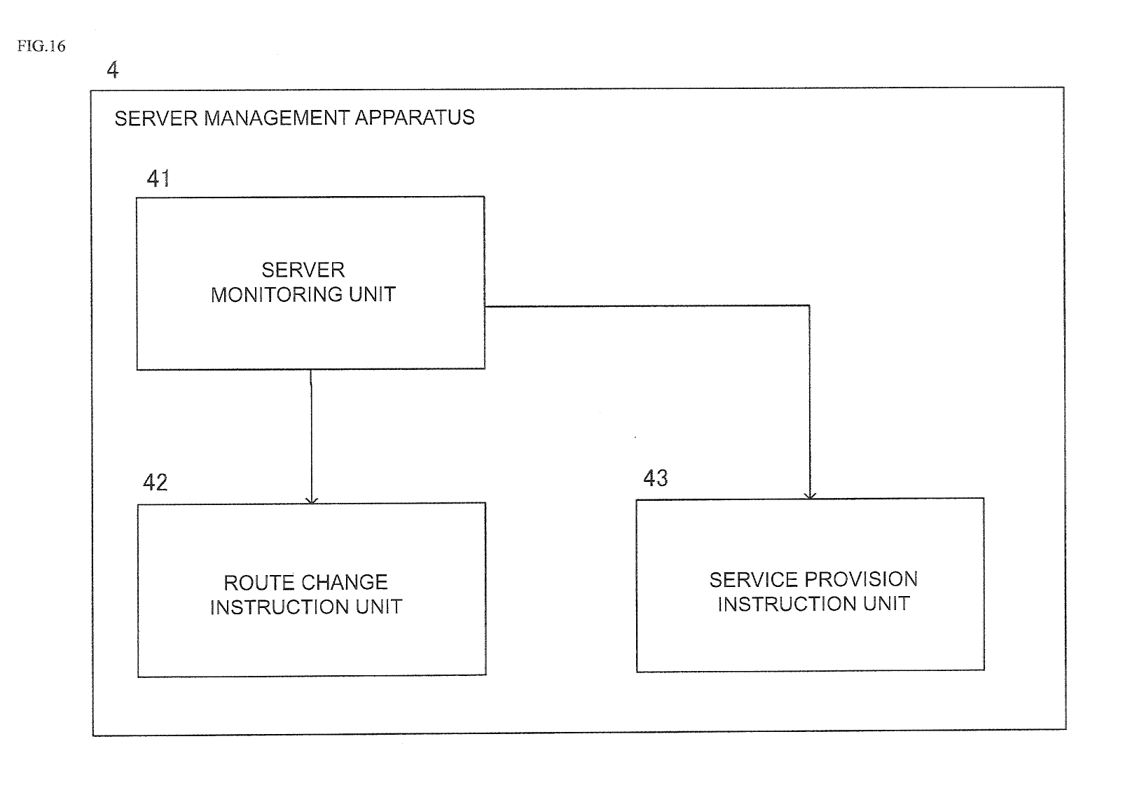

FIG. 16 is a block diagram illustrating a configuration example of a server management apparatus according to the present invention. FIG. 1 illustrates a configuration of a service provision system including the server management apparatus according to the present invention. In FIGS. 16 and 1, a server management apparatus (4) comprises: a server monitoring unit (41) that monitors an activity state of an active server (3a) that provides a service to at least one client (5) via a plurality of switches (1a to 1c); a route change instruction unit (42) that instructs, when there is no reply from the active server (3a), a route control apparatus (2), managing routing for the plurality of switches (1a to 1c), to change a packet forwarding route (path); and a service provision instruction unit (43) that recognizes that the active server (3a) is stopped if there is no reply from the active server (3a) after a forwarding route is changed and instructs a standby server (3b) to provide the service instead of the active server (3a).

In addition, it is preferable that the server monitoring unit (41) monitors an activity state of the active server (3a) via a switch (1a) connected to the client(s) (5) with a least hop number among the plurality of switches (1a to 1c).

In addition, it is preferable that, if it is recognized that the active server (3a) is stopped, the route change instruction unit (42) instructs the route control apparatus (2) to change a packet forwarding route (path) between the client (5) and the active server (3a) to a packet forwarding route (path) between the client (5) and the standby server (3b).

In addition, it is preferable that, if it is recognized that the active server (3a) is stopped, the service provision instruction unit (43) instructs the standby server (3b) to activate an application program relating to provision of the service.

If there is still no reply from the active server (3a) even when there is no reply from the active server (3a) and the route change instruction unit (42) instructs the route control apparatus (2) to change a packet forwarding route a predetermined number of times, the service provision instruction unit (43) may recognize that the active server (3a) is stopped.

If the server monitoring unit (41) determines that the active server (3a) is active, the server monitoring unit (41) may check an activity state of an application program relating to the service, and if the application is not active, the service provision instruction unit (43) may instruct the active server (3a) to reactivate the application.

Based on the server management apparatus (4) according to the present invention, even if service provision by a service provision system including the active server (3a) and the standby server (3b) is stopped by a failure in a server or by a failure in a network connecting the client (5) and both the servers (3a and 3b), the service can be recovered.

In addition, the server management apparatus (4) according to the present invention can determine whether provision of a service is stopped by a failure in a server or a failure in a network connecting the client (5) and the servers. This is because, if there is no reply from the server even after the packet forwarding route is changed, it is highly probable that a failure is caused in the server.

In addition, the server management apparatus (4) according to the present invention can improve service availability. This is because the packet forwarding route between the server and the client (5) is also changed when switching from the active server (3a) to the standby server (3b) is executed.

According to the present invention, the following modes are possible.

### <Mode 1>

There is provided a server management apparatus according to the above first aspect.

### <Mode 2>

The server monitoring unit may monitor the activity state of the active server via a switch connected to the client with a least hop number among the plurality of switches.

### <Mode 3>

The route change instruction unit may instruct the route control apparatus to change a packet forwarding route between the client and the active server to a packet forwarding route between the client and the standby server if the route change instruction unit recognizes that the active server is stopped.

### <Mode 4>

The service provision instruction unit may instruct the standby server to activate an application program relating to provision of the service if the service provision instruction unit recognizes that the active server is stopped.

### <Mode 5>

The service provision instruction unit may recognize that the active server is stopped, if there is no reply from the active server even when there is no reply from the active server and the route change instruction unit instructs the route control apparatus to change a packet forwarding route a predetermined number of times.

### <Mode 6>

If the server monitoring unit determines that the active server is active, the server monitoring unit may check an activity state of an application program relating to the service; and if the application is not active, the service provision instruction unit may instruct the active server to reactivate the application.

### <Mode 7>

A service provision system may comprise: an active server; a standby server; a route control apparatus; and the above server management apparatus.

### <Mode 8>

There is provided a server management method according to the above second aspect.

### <Mode 9>

In the server management method, the monitoring may comprise monitoring an activity state of the active server via a switch connected to the client with a least hop number among the plurality of switches.

### <Mode 10>

The server management method may further comprise: changing a communication route between the client and the active server to a communication route between the client and the standby server if the server management apparatus recognizes that the active server is stopped.

### <Mode 11>

There is provided a program according to the above third aspect.

### <Mode 12>

In the program, the monitoring may comprise monitoring the activity state of the active server via a switch connected to the client with a least hop number among the plurality of switches.

### <Mode 13>

The program may cause a computer to execute: changing a communication route between the client and the active server to a communication route between the client and the standby server if it is recognized that the active server is stopped.

### First Exemplary Embodiment

A service provision system according to a first exemplary embodiment will be described in detail with reference to the drawings. FIG. 1 is a block diagram illustrating a configuration of the service provision system according to the present exemplary embodiment.

With reference to FIG. 1, the service provision system according to the present exemplary embodiment comprises: switches 1a to 1c included in a network; a route (path) control apparatus 2 that controls routing (path) for a switch group 1; servers 3a and 3b that provide services via the network; a server management apparatus 4 that manages the servers 3a and 3b; and a client 5.

The servers 3a and 3b comprise computers that execute service provision applications. In the present exemplary embodiment, the servers 3a and 3b are active and standby servers, respectively, and in a normal state, the server 3a provides services. In addition, upon receiving an operation state check packet, the servers 3a and 3b transmit a reply.

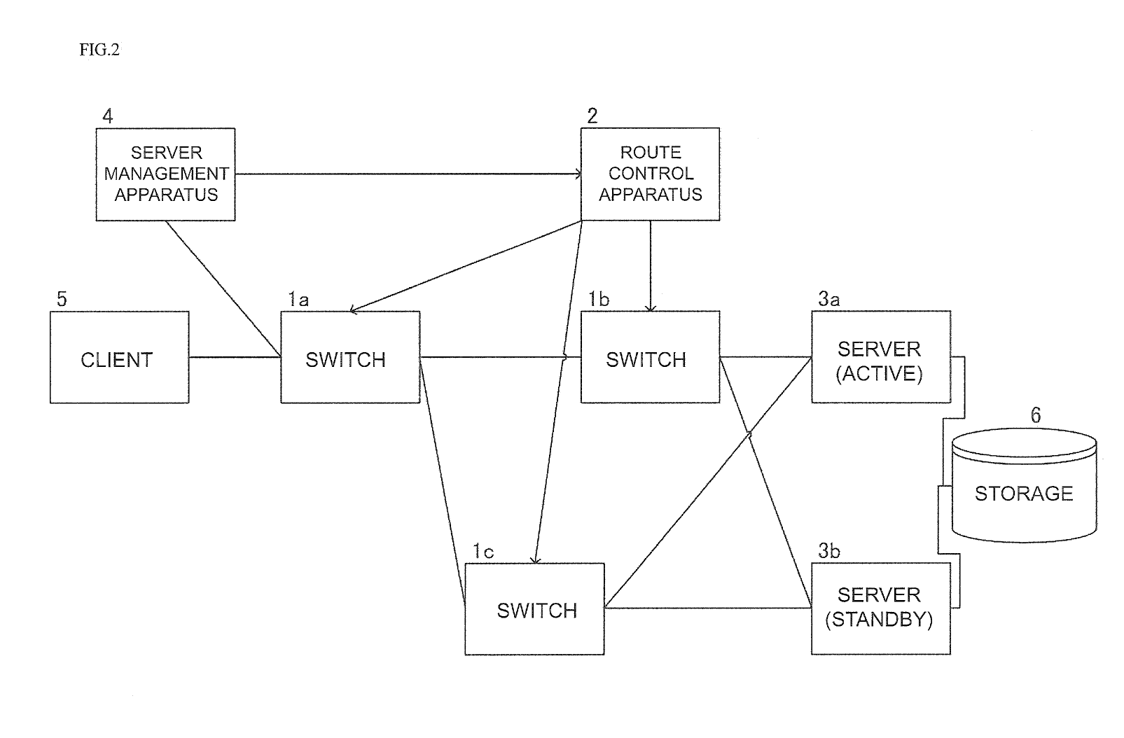

FIG. 2 is a block diagram illustrating another configuration of the service provision system according to the present exemplary embodiment. As illustrated in FIG. 2, the servers 3a and 3b may share data in a storage unit 6. Communication may be used so that data is synchronized between the servers 3a and 3b.

The client 5 is an apparatus such as a computer and uses services provided by the servers 3a and 3b via a network. There may be a plurality of clients 5 (not shown).

The network includes the switches 1a to 1c. The switches 1a to 1c may be network switches such as Ethernet (registered trademark) network switches, for example. The number of switches, connection among the switches, and connection among the servers 3a and 3b and the client 5 are not limited to the mode illustrated in FIG. 1.

The server management apparatus 4 monitors state of the server 3a and determines a role, i.e., function (active or standby) of each of the servers 3a and 3b.

The route control apparatus 2 controls packet forwarding executed by each of the switches 1a to 1c. The server management apparatus 4 and the route control apparatus 2 may be integrated.

A technique referred to as OpenFlow described in Non-Patent Literature 1 may be used for the switches 1a to 1c and the route control apparatus 2.

In the OpenFlow, communication is deemed as an end-to-end flow, and routing (path) control, failure recovery, load distribution, and optimization are executed for each flow. An OpenFlow switch (OFS: OpenFlow Switch corresponding to the switches 1a to 1c) serving as a forwarding node includes a secure channel for communication with an OpenFlow controller (OFC: OpenFlow Controller corresponding to the route control apparatus 2) serving as a control server. The OpenFlow switch operates in accordance with a flow table appropriately added or rewritten by the OpenFlow controller.

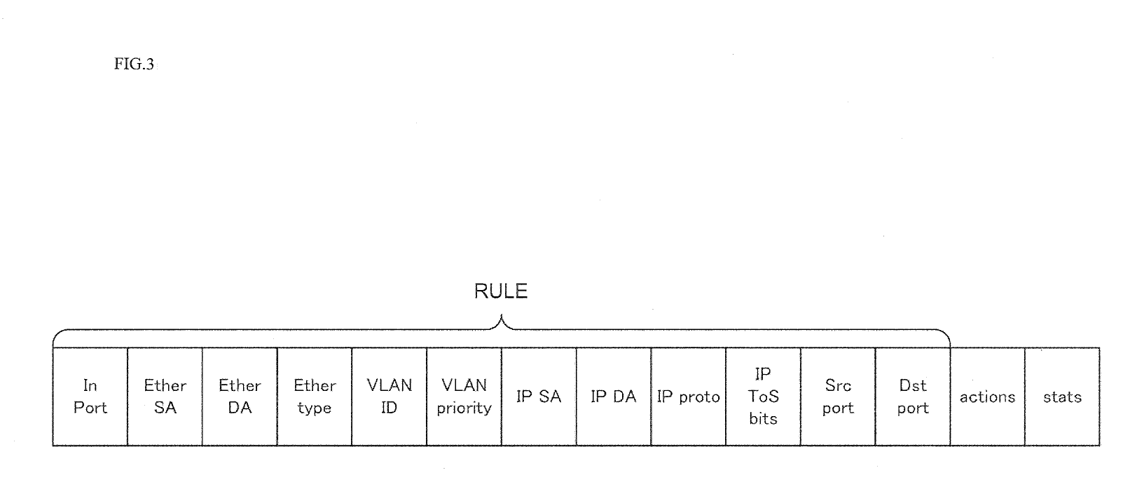

FIG. 3 illustrates an entry in the flow table in OpenFlow, as an example. In the flow table in FIG. 3, a group of: a rule matched with packet headers; actions defining process contents; and flow statistics information (stats) is defined for each flow.

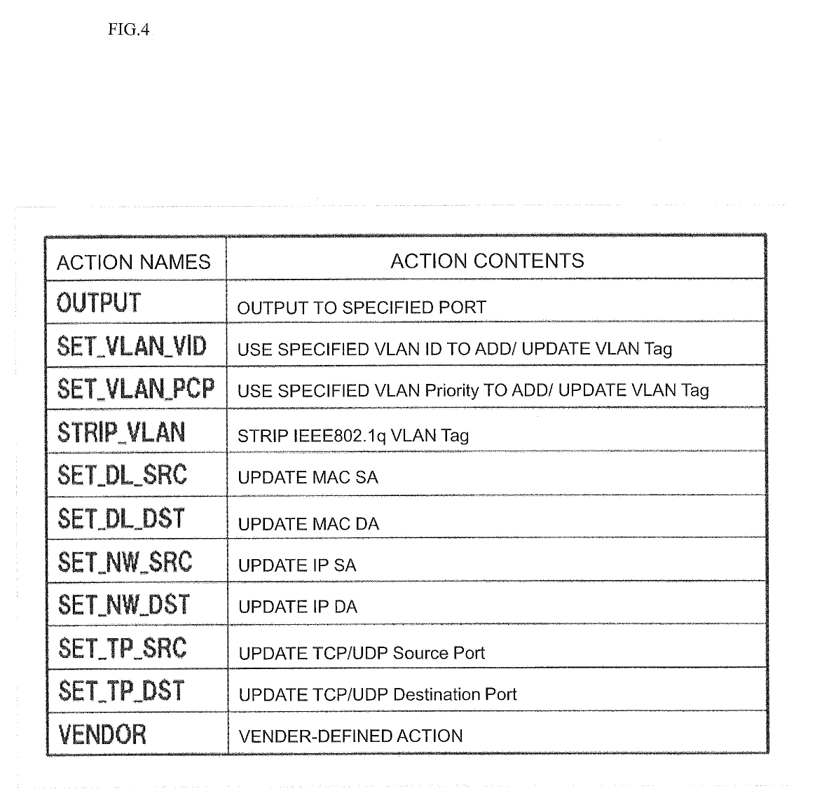

FIG. 4 is a table illustrating action names and action contents defined in Non-Patent Literature 2, as an example. OUTPUT is an action for outputting data to a specified port (interface). SET_VLAN_VID to SET_TP_DST are actions for modifying packet header fields. The disclosure of NPL2 is incorporated herein by reference thereto.

For example, upon receiving a packet, the OpenFlow switch searches the flow table (FIG. 3) for an entry having a rule (FlowKey) that matches header information of the received packet. As a result of the search, if an entry matching the received packet is found, the OpenFlow switch executes process contents described in the action field of the entry on the received packet. If, as a result of the search, no entry matching the received packet is found, the OpenFlow switch forwards the received packet to the OpenFlow controller via the secure channel to request the OpenFlow controller to determine a packet route based on the source and destination of the received packet. Upon receiving a flow entry realizing the route (path), the OpenFlow switch updates the flow table. In this way, the OpenFlow switch uses an entry stored in the flow table as a process rule to forward a packet.

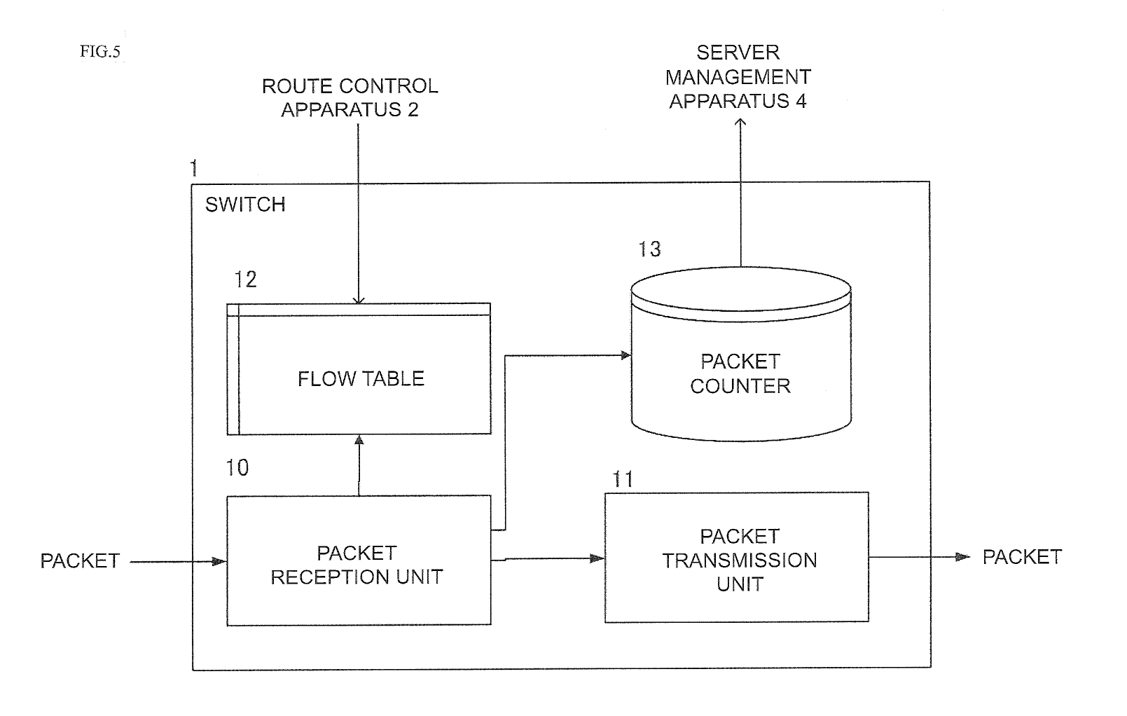

FIG. 5 is a block diagram illustrating a configuration of any one of the switches 1a to 1c when the OpenFlow technique is used. In FIG. 5, each of the switches 1a to 1c comprises a packet reception unit 10, a packet transmission unit 11, a flow table 12, and a packet counter 13.

The switches 1a to 1c use the packet reception unit 10 to receive a packet and use the packet transmission unit 11 to send the packet to a suitably connected apparatus (to any of the switches 1a to 1c, the servers 3a and 3b, the client 5, and the like), in accordance with the flow table 12 set by the route control apparatus 2.

In addition, the packet counter 13 records the number of packets that have passed through the switch. The packet counter 13 may record the number as a status in the flow table 12.

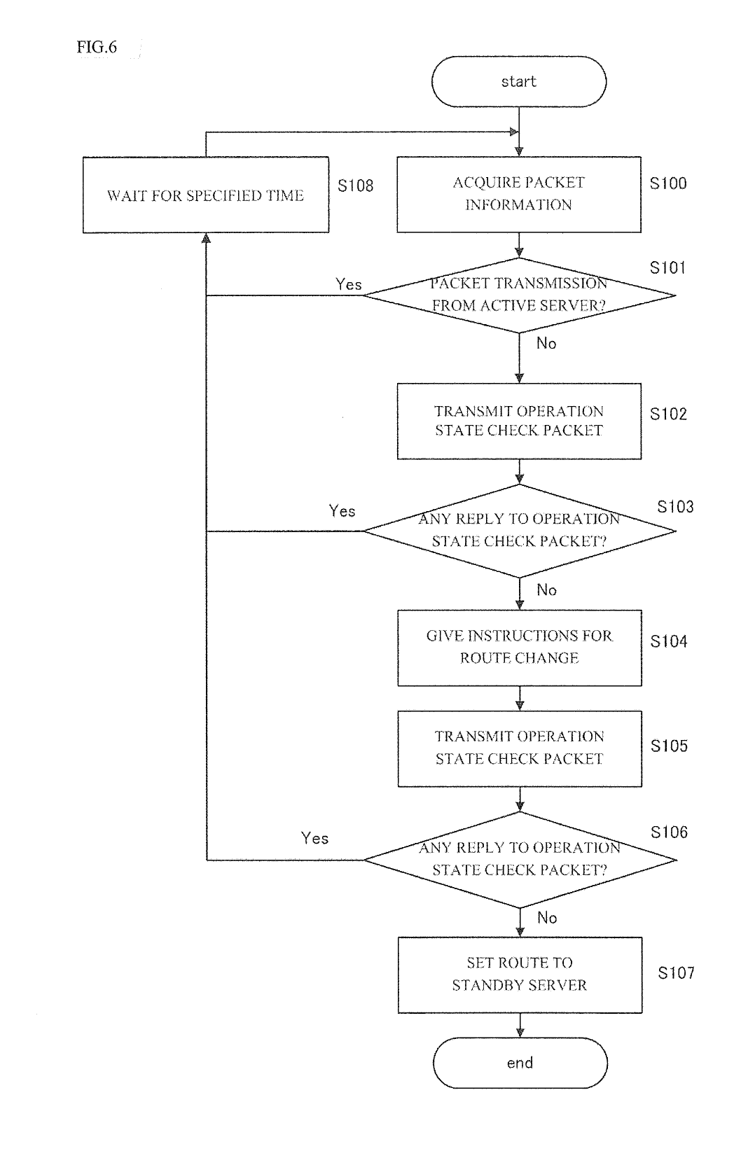

FIG. 6 is a flow chart illustrating an operation of the server management apparatus 4.

With reference to FIG. 6, the server management apparatus 4 acquires the number of packets, whose destination is the server 3a or which are transmitted from the server 3a, from the switch 1a (step S100). If there is any packet transmitted from the server 3a (Yes in step S101), the operation proceeds to step S108. If not (No in step S101), the operation proceeds to step S102.

The switch 1a transmits an operation state check packet to the server 3a (step S102). If there is a reply to the operation state check packet (Yes in step S103), the operation proceeds to step S108.

On the other hand, if there is no reply to the operation state check packet (No in step S103), the server management apparatus 4 instructs the route control apparatus 2 to change the route (path) between the switch 1a and the server 3a (step S104) and causes the switch 1a to send an operation state check packet to the server 3a (step S105).

If there is no reply to the operation state check packet (No in step S106), the server management apparatus 4 instructs the route control apparatus 2 to set a communication route between the switch 1a and the server 3b so that the packet is transmitted to the server 3b on the set communication route (path) (step S107).

On the other hand, if there is a reply to the operation state check packet (Yes in step S106), the server management apparatus 4 waits for a time period specified in the system (step S108), and the operation proceeds to step S100.

Thus, the communication route (path) is first changed and activity of the server 3a is then checked. In this way, a failure can be managed in view of the communication route from the client 5.

In step S100, the server management apparatus 4 may acquire the difference between the current packet number and the previous packet number. The server management apparatus 4 may store the previous packet number to calculate the difference between the previous and current packet numbers.

In addition, if it is determined that no packet has been transmitted to the server 3a in step S101, the operation may proceed to step S108. In this way, since no process is executed in the server 3, there is no need to execute the operation state check executed when no packet is transmitted from the server 3. Namely, network load associated with the operation state check can be reduced, and processes of the server 3a associated with the operation state check can be reduced.

As the operation state check packet in steps S102 and S105, for example, an ICMP (Internet Control Message Protocol) ECHO may be transmitted.

If OpenFlow is used, the operation state check packet can be transmitted from the server management apparatus 4 to the switch 1a via the OFC (route control apparatus 2) through a secure channel. Likewise, the reply to the operation state check packet can be transmitted from the OFC to the server management apparatus 4 through a secure channel.

In steps S103 and S106, the server management apparatus 4 may determine that there is no reply to the operation state check packet if the server management apparatus 4 does not receive a reply within a time period set in the system.

For example, the communication route in step S107 can be set by calculating a communication route based on a Dijkstra method and by recording packet forwarding rules in the flow tables of the switches 1a to 1c included in the communication route.

In addition, in step S107, the communication route between the switch 1a and the server 3a may be deleted. In this way, the flow tables of the switches 1a to 1c can be used economically.

In addition, by using the switch 1a connected to the client 5, which uses the server 3a, as a switch for which the packet number is checked, the route formed by the switches 1a to 1c enabling communication between the client 5 and the server 3a can be checked comprehensively.

In addition, if the client 5 is connected to a switch outside the control of the route control apparatus 2, it is desirable that the packet number is checked on the switch 1a, which first receives a communication from the client 5 and which is under the control of the route control apparatus 2.

If OpenFlow is used, as the switch 1a transmitting a monitoring and operation state check packet, an OFS that has transmitted a first packet to the OFC may be selected.

### Second Exemplary Embodiment

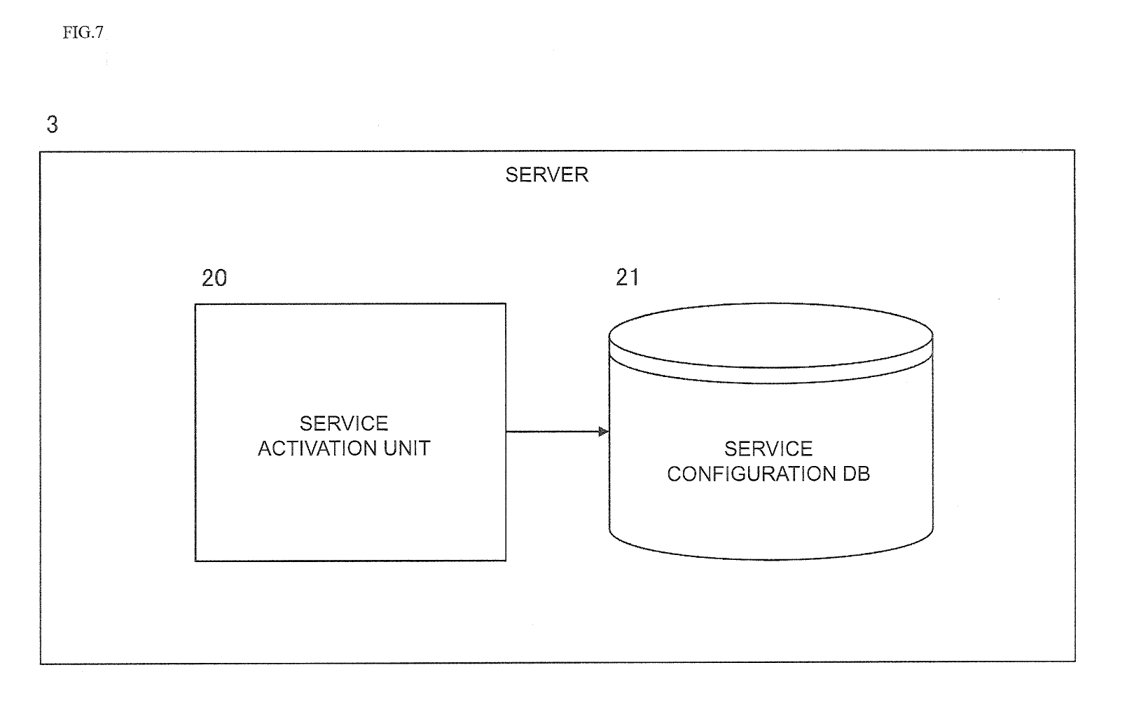

A service provision system according to a second exemplary embodiment will be described with reference to the drawings. FIG. 7 is a block diagram illustrating a configuration of servers 3a and 3b in the service provision system according to the present exemplary embodiment.

With reference to FIG. 7, the servers 3a and 3b comprise a service activation unit 20 and a service configuration DB 21.

The service activation unit 20 activates an application program corresponding to a specified service, based on instructions from a server management apparatus 4. For this operation, the service activation unit 20 uses the service configuration DB 21 in which a service startup process is recorded.

The service configuration DB 21 is a data base in which a service identifier and a service startup process are recorded as a set.

The service startup process may be described in a shell script, and the service activation unit 20 may be configured to activate the shell script.

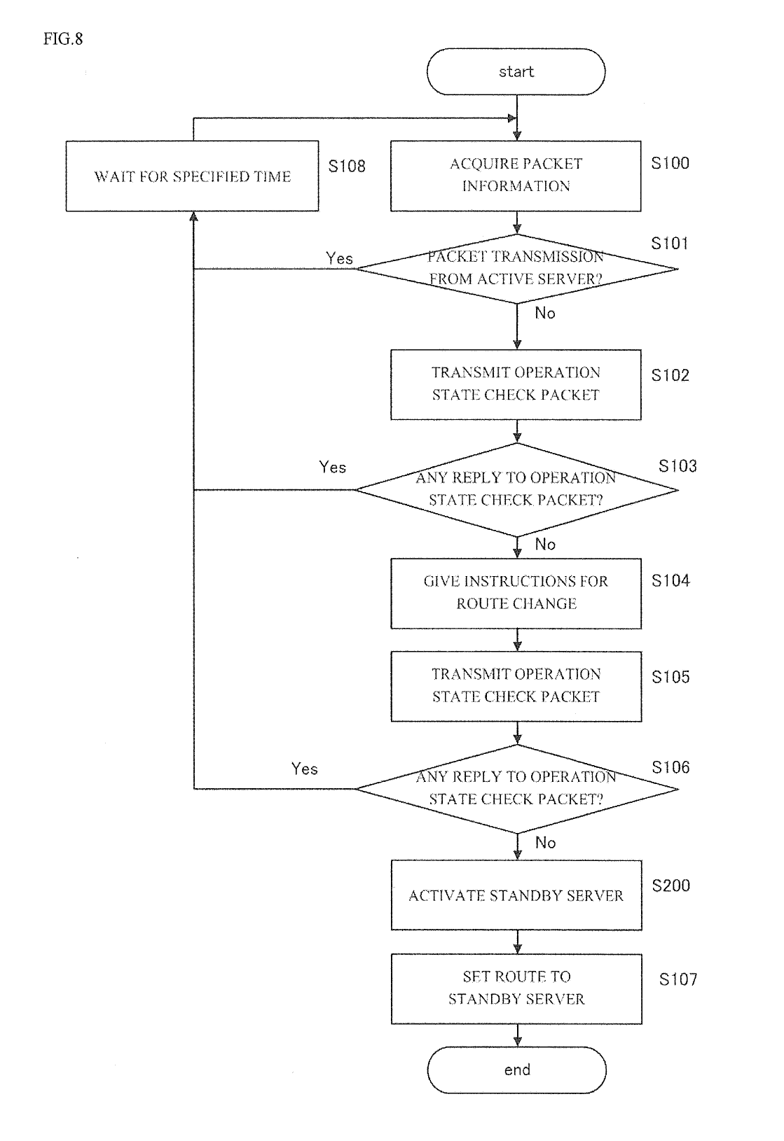

FIG. 8 is a flow chart illustrating an operation of the server management apparatus 4. The operation of the server management apparatus 4 will be described with reference to FIG. 8.

The operation of the server management apparatus 4 according to the present exemplary embodiment is the same as that of the server management apparatus 4 according to the first exemplary embodiment, except that the operation proceeds to step S200 if there is no reply to the operation state check packet (No in step S106).

In step S200, the server management apparatus 4 instructs the standby server 3b to activate a service. Next, the operation proceeds to step S107.

When instructed to activate a service, the standby server 3b executes a service startup process recorded in the service configuration DB 21.

In this way, the standby server 3b does not need to run a service provision application program, unless the standby server 3b takes over a process from the active server 3a. Thus, CPU load in the standby server 3b can be reduced.

### Third Exemplary Embodiment

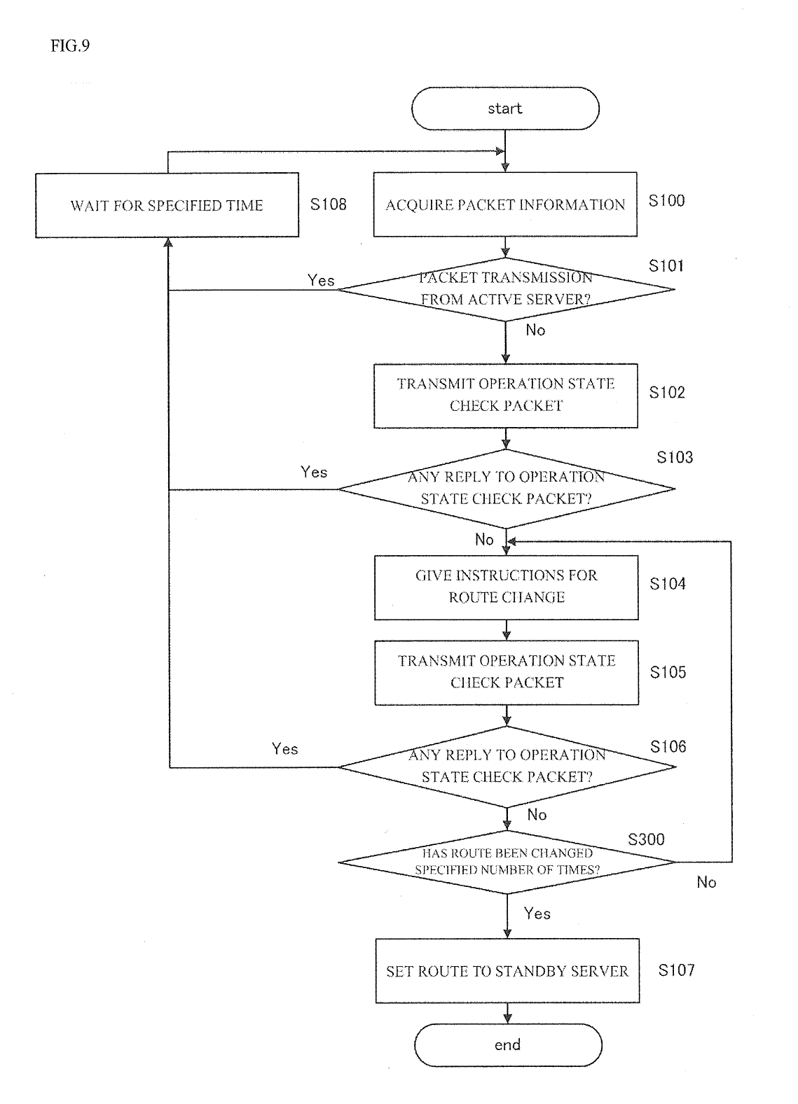

A server management apparatus according to the third exemplary embodiment will be described with reference to the drawings. FIG. 9 is a flow chart illustrating an operation of a server management apparatus 4 according to the present exemplary embodiment.

The operation of the server management apparatus 4 according to the present exemplary embodiment is the same as that of the server management apparatus 4 according to the first exemplary embodiment, except that the operation proceeds to step S300 if there is no reply to the operation state check packet (No in step S106).

If the server management apparatus 4 determines that a route change is executed more than the number of times defined in the system (Yes in step S300), the operation proceeds to step S107. If not (No in step S300), the operation proceeds to step S104 to try another communication route.

In this way, even if many communication routes are possible between the switch 1a and the server 3a, an operation state check via each communication route can be executed. Namely, the present exemplary embodiment is applicable to a network that can have many communication routes.

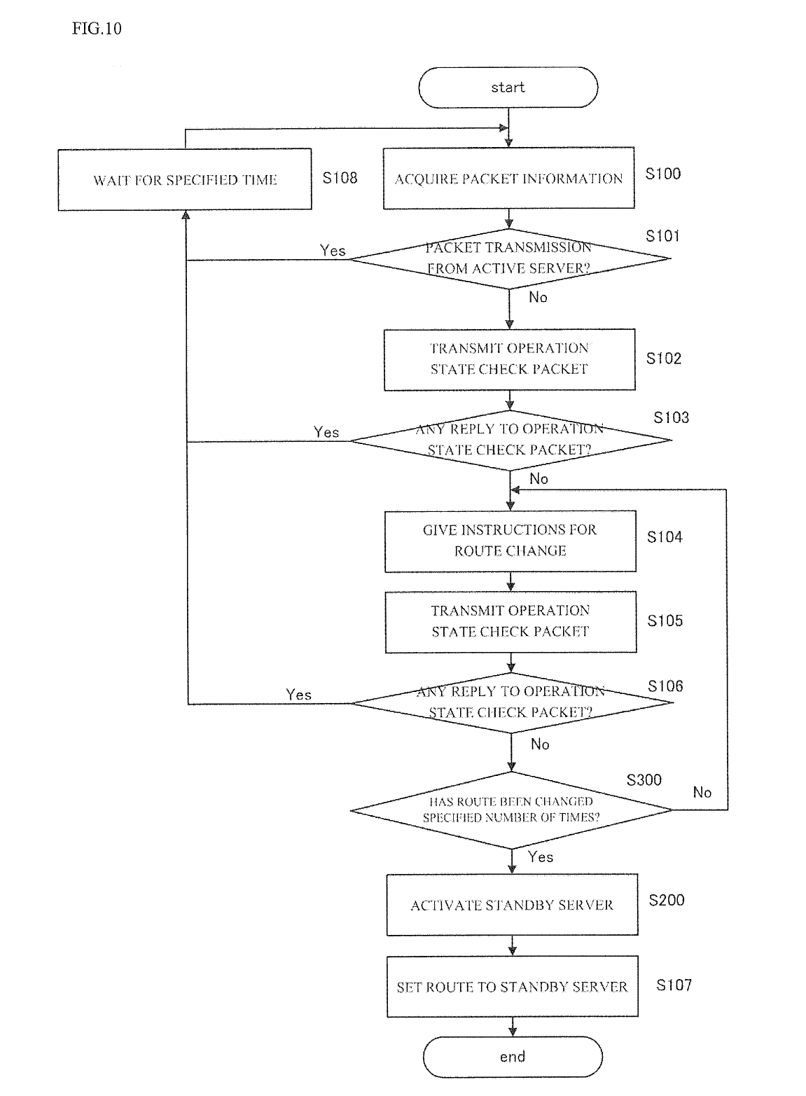

FIG. 10 is a flow chart illustrating another operation of the server management apparatus 4 according to the present exemplary embodiment. With reference to FIG. 10, according to the present exemplary embodiment, as in the second exemplary embodiment, the standby server 3b may be activated (step S200). In this way, as in the service provision system according to the second exemplary embodiment, CPU load in the standby server 3b can be reduced.

### Fourth Exemplary Embodiment

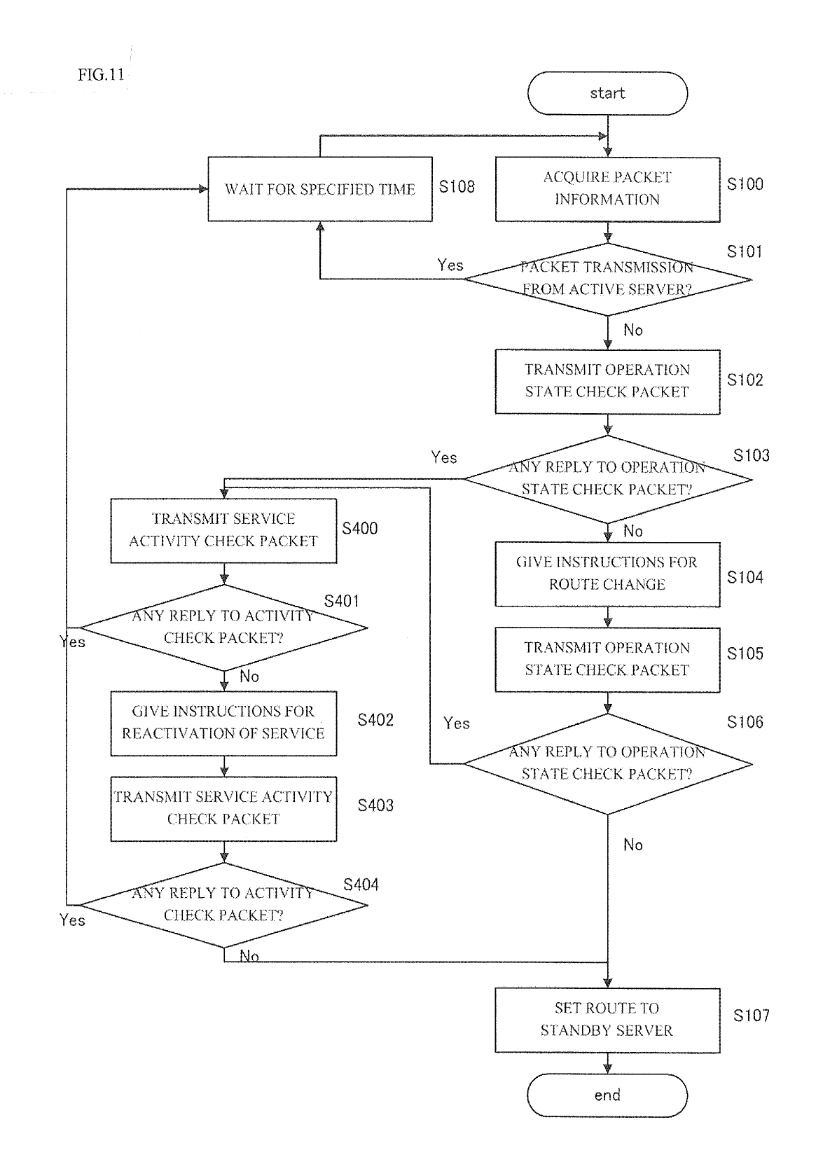

A server management apparatus according to a fourth exemplary embodiment will be described with reference to the drawings. FIG. 11 is a flow chart illustrating an operation of a server management apparatus 4 according to the present exemplary embodiment.

The operation of the server management apparatus 4 according to the present exemplary embodiment is the same as that of the server management apparatus 4 according to the first exemplary embodiment, except that the operation proceeds to step S400 if there is a reply to the operation state check packet (Yes in step S103 or Yes in step S106).

The server management apparatus 4 transmits a service activity check packet (step S400). If there is a reply to the activity check packet (Yes in step S401), the operation proceeds to step S108.

However, if there is no reply to the activity check packet (No in step S401), the server management apparatus 4 instructs the active server 3a to reactivate the service (step S402).

Next, the server management apparatus 4 transmits a service activity check packet (step S403). If there is a reply to the activity check packet (Yes in step S404), the operation proceeds to step S108. If not (No in step S404), the operation proceeds to step S107.

When instructed to reactivate the service, the server 3a executes a service startup process recorded in the service configuration DB 2l after the server 3a executes a service termination process.

As the service activity check packet in steps S400 and S403, for example, a HELLO packet may be transmitted to a port used for the service.

In addition, in steps S401 and S404, the server management apparatus 4 may determine that there is no reply to the service activity check packet if the server management apparatus 4 does not receive a reply within a time period set in the system.

The service activation unit 20 according to the present exemplary embodiment terminates an application program corresponding to a specified service, based on instructions from the server management apparatus 4. For this operation, the service activation unit 20 uses the service configuration DB 21 in which a service termination process is recorded.

The service configuration DB 21 is a data base in which a service identifier and a service termination process are recorded as a set.

The service termination process may be described in a shell script, and the service activation unit 20 may be configured to activate the shell script.

In this way, if a service provision application is stopped while the server 3a is active, the service can be provided by reactivating the application. Namely, the present exemplary embodiment is applicable to application failure.

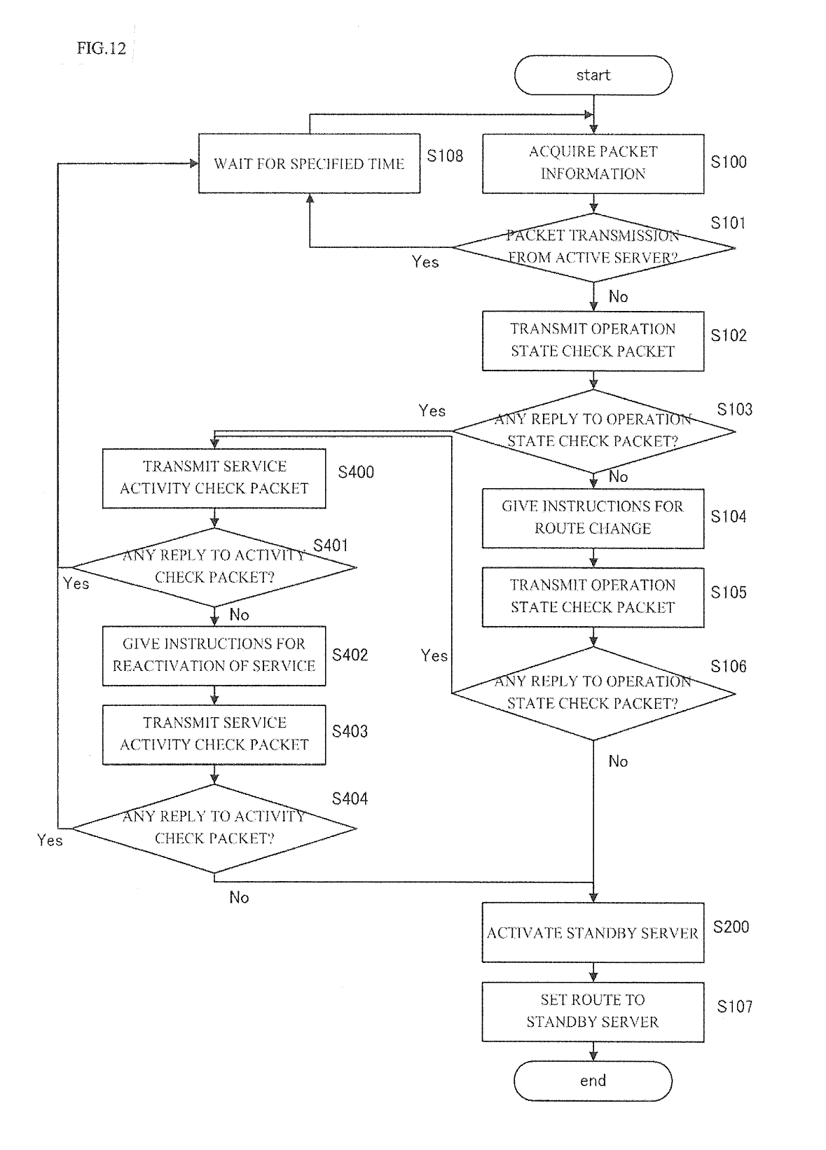

FIG. 12 is a flow chart illustrating another operation of the server management apparatus 4 according to the present exemplary embodiment. With reference to FIG. 12, according to the present exemplary embodiment, the standby server 3b may be activated (step S200), as in the second exemplary embodiment. In this way, as in the service provision system according to the second exemplary embodiment, CPU load in the standby server 3b can be reduced.

### Fifth Exemplary Embodiment

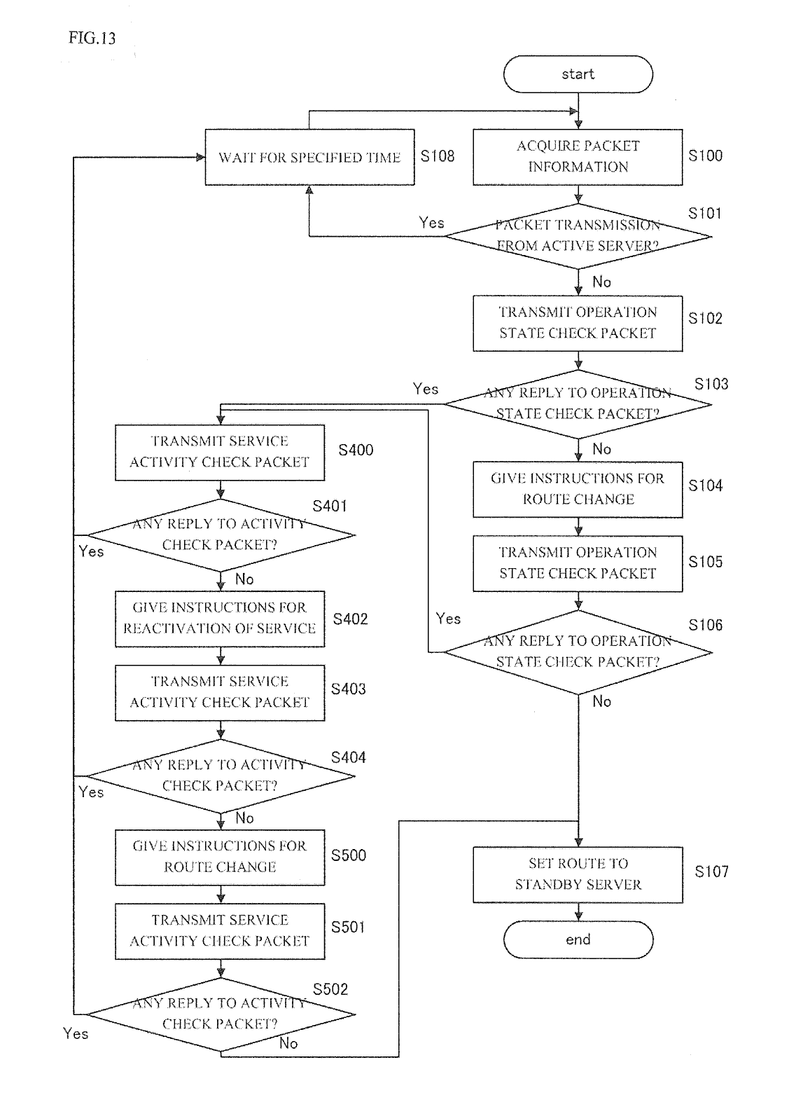

A server management apparatus according to a fifth exemplary embodiment will be described with reference to the drawings. FIG. 13 is a flow chart illustrating an operation of a server management apparatus 4 according to the present exemplary embodiment.

The operation of the server management apparatus 4 according to the present exemplary embodiment is the same as that (FIG. 11) of the server management apparatus 4 according to the fourth exemplary embodiment, except that the operation proceeds to step S500 if there is no reply to the activity check packet (No in step S404).

The server management apparatus 4 instructs the route control apparatus 2 to change the communication route between the switch la and the server 3a to another communication route (step S500).

Next, the server management apparatus 4 transmits a service activity check packet (step S501). If there is a reply to the activity check packet (Yes in step S502), the operation proceeds to step S108. Otherwise (No in step S502), the operation proceeds to step S107.

In this way, even if there is a communication route that does not allow communication for a certain service, the service can be provided.

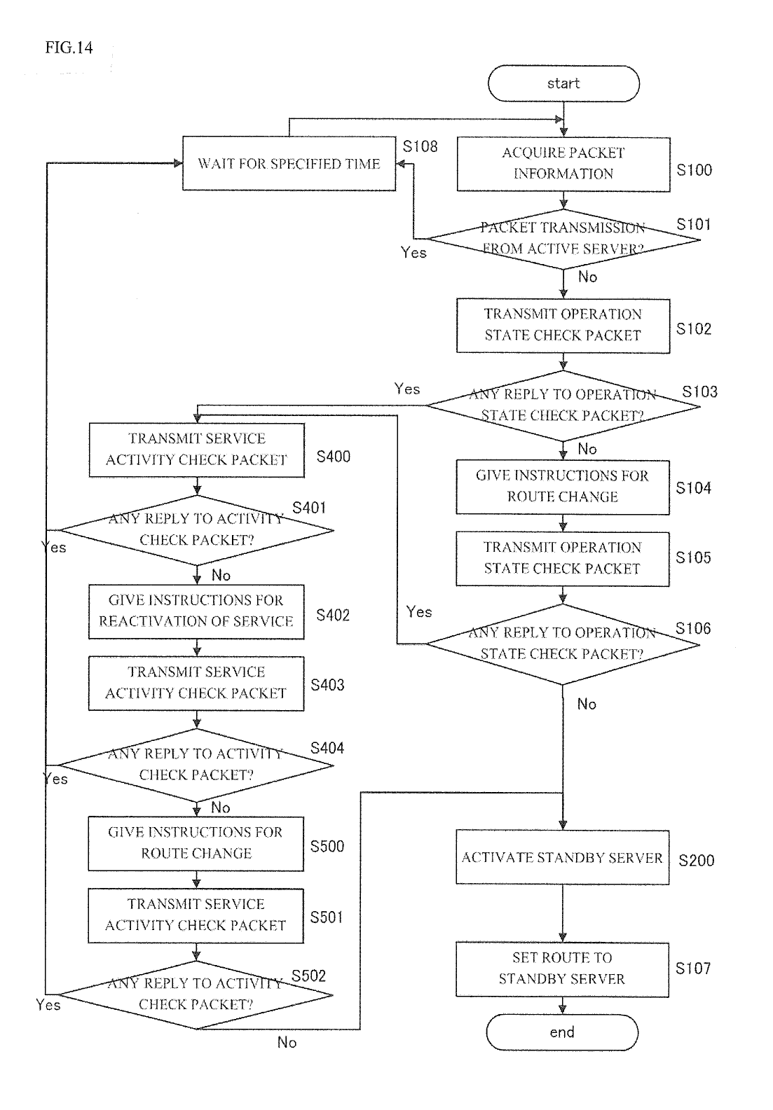

FIG. 14 is a flow chart illustrating another operation of the server management apparatus 4 according to the present exemplary embodiment. With reference to FIG. 14, according to the present exemplary embodiment, as in the second exemplary embodiment (FIG. 8), the standby server 3b may be activated (step S200). In this way, as in the service provision system according to the second exemplary embodiment, CPU load in the standby server 3b can be reduced.

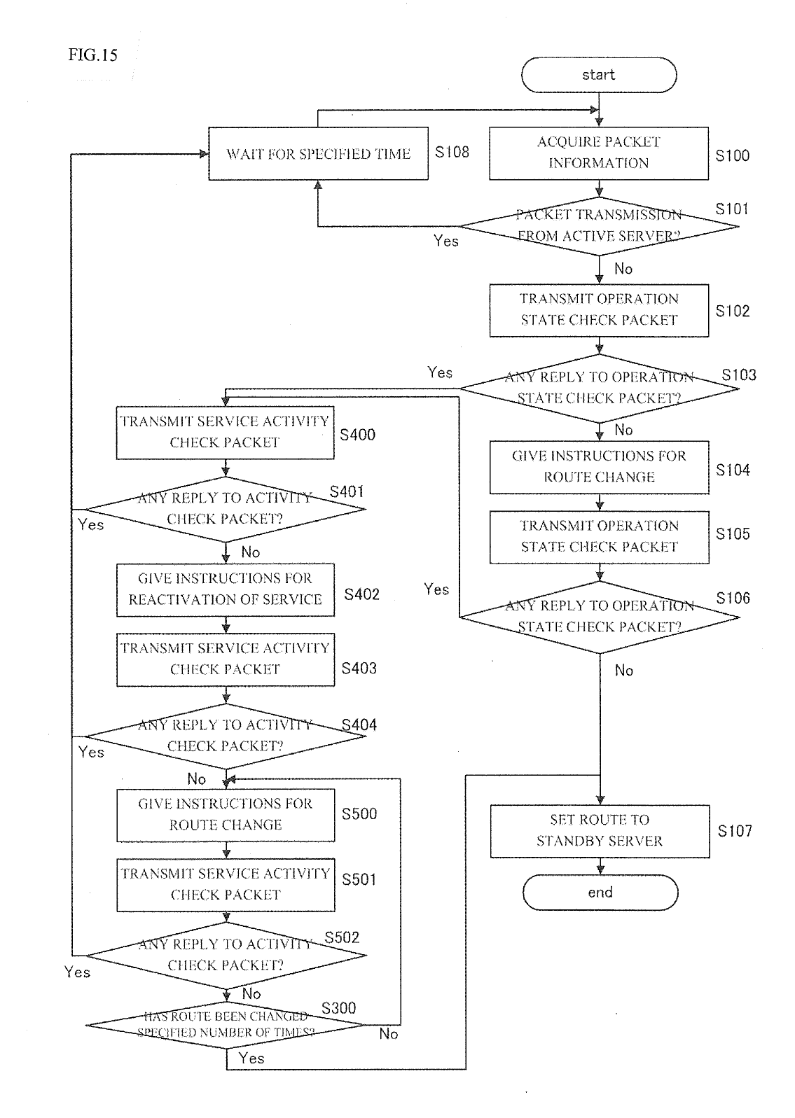

FIG. 15 is a flow chart illustrating still another operation of the server management apparatus 4 according to the present exemplary embodiment. With reference to FIG. 15, according to the present exemplary embodiment, as in the third exemplary embodiment (FIG. 9), if there is no reply (No in step S502), the operation proceeds to step S500 to try a plurality of communication routes.

In this way, when many communication routes are possible between the switch 1a and the server 3a, even if there is a communication route that does not allow communication for a certain service, the service can be provided.

Modifications and adjustments of the exemplary embodiments are possible within the scope of the overall disclosure (including claims) of the present invention and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

### REFERENCE SIGNS LIST

1, 1a to 1c switch
2 route control apparatus (routing controller)
3, 3a, 3b server
4 server management apparatus (server manager)
5 client
6 storage
10 packet reception unit
11 packet transmission unit
12 flow table
13 packet counter
20 service activation unit
21 service configuration DB
41 server monitoring unit
42 route change instruction unit
43 service provision instruction unit

What is claimed is:

1. A server management apparatus, comprising:
a server monitoring unit that monitors activity state of an active server that provides a service to a client(s) via a plurality of switches;
a route change instruction unit that instructs a route control apparatus, managing routing for the plurality of switches, to change a packet forwarding route if there is no reply from the active server; and
a service provision instruction unit that recognizes that the active server is stopped if there is no reply from the active server after a forwarding route is changed and instructs a standby server to provide the service instead of the active server.

2. The server management apparatus according to claim 1, wherein:
the route change instruction unit instructs the route control apparatus to change a packet forwarding route between the client(s) and the active server to a packet forwarding route between the client(s) and the standby server if the route change instruction unit recognizes that the active server is stopped.

3. The server management apparatus according to claim 1, wherein:
the server monitoring unit monitors the activity state of the active server via a switch connected to the client(s) with a least hop number among the plurality of switches.

4. The server management apparatus according to claim 1, wherein:
the service provision instruction unit instructs the standby server to activate an application program relating to provision of the service if the service provision instruction unit recognizes that the active server is stopped.

5. The server management apparatus according to claim 1, wherein:
the service provision instruction unit recognizes that the active server is stopped, if there is no reply from the active server even when there is no reply from the active server and the route change instruction unit instructs the route control apparatus to change a packet forwarding route a predetermined number of times.

6. The server management apparatus according to claim 1, wherein:
if the server monitoring unit determines that the active server is active, the server monitoring unit checks activity state of an application program relating to the service; and
if the application is not active, the service provision instruction unit instructs the active server to reactivate the application.

7. A service provision system, comprising:
an active server;
a standby server;
a route control apparatus; and
the server management apparatus according to claim 1.

8. A server management method, comprising:
by a server management apparatus, monitoring activity state of an active server that provides a service to a client(s) via a plurality of switches;
instructing a route control apparatus, managing routing for the plurality of switches, to change a packet forwarding route if there is no reply from the active server; and
recognizing that the active server is stopped if there is no reply from the active server after a forwarding route is changed and instructing a standby server to provide the service instead of the active server.

9. The server management method according to claim 8, further comprising:
changing a communication route between the client(s) and the active server to a communication route between the client(s) and the standby server if the server management apparatus recognizes that the active server is stopped.

10. The server management method according to claim 8, wherein:
the monitoring comprises monitoring activity state of the active server via a switch connected to the client with a least hop number among the plurality of switches.

11. A non-transitory computer-readable storage medium, storing a program that causes a computer to execute:
monitoring an activity state of an active server that provides a service to a client(s) via a plurality of switches;
instructing a route control apparatus, managing routing for the plurality of switches, to change a packet forwarding route if there is no reply from the active server; and
recognizing that the active server is stopped if there is no reply from the active server after a forwarding route is changed and instructing a standby server to provide the service instead of the active server.

12. The non-transitory computer-readable storage medium according to claim 11, wherein
the program causes a computer to execute:
changing a communication route between the client(s) and the active server to a communication route between the client and the standby server if it is recognized that the active server is stopped.

13. The non-transitory computer-readable storage medium according to claim 11, wherein:
the monitoring comprises monitoring activity state of the active server via a switch connected to the client with a least hop number among the plurality of switches.
